(19) United States
(12) Patent Application Publication
(10) Pub. No.: US 2006/0063102 A1
(43) Pub. Date: Mar. 23, 2006

(54) Positive resist composition

(75) Inventors: Naotaka Kubota, Kawasaki-shi (JP); Kiyoshi Ishikawa, Kawasaki-shi (JP); Mitsuru Sato, Kawasaki-shi (JP); Tasuku Matsumiya, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOKYO OHKA KOGYO CO., LTD., Kawasaki-shi (JP)

(21) Appl. No.: 10/536,711

(22) PCT Filed: Dec. 1, 2003
(86) PCT No.: PCT/JP03/15346

§ 371 Date: May 27, 2005

(30) Foreign Application Priority Data
Dec. 2, 2002 (JP) 2002-350466
May 28, 2003 (JP) 2003-151573

(51) Int. Cl. G03C 1/76; G03C 1/492

(52) U.S. Cl. 430/270.1

(57) ABSTRACT

There is provided a positive resist composition which, during resist pattern formation, can prevent the collapse of very fine resist patterns during the drying step following developing. This positive resist composition is used in a resist pattern formation method comprising a step, within the lithography process, for substituting a liquid remaining on the substrate following alkali developing with a critical drying liquid, and then drying this critical drying liquid by causing passage through a critical state. The positive resist composition comprises a resin component (A), which has an alkali-soluble unit content of less than 20 mol %, contains an acid dissociable, dissolution inhibiting group, and displays increased alkali solubility under action of acid, an acid generator component (B) that generates acid on exposure, and an organic solvent (C) for dissolving the components (A) and (B), and moreover, the component (A) comprises a structural unit (a1) containing an acid dissociable, dissolution inhibiting group, a structural unit (a2) containing a lactone unit, and a structural unit (a3) containing a polycyclic group with an alcoholic hydroxyl group.

### TECHNICAL FIELD

The present invention relates to a positive resist composition used in a resist pattern formation method that comprises a critical drying step.

### BACKGROUND ART

(Patent Reference 1)

Japanese Unexamined Patent Application, First Publication No. Hei 1-220828, page 4, upper right column.

(Patent Reference 2)

Japanese Unexamined Patent Application, First Publication No. Hei 9-82629, paragraphs [0024] and [0026].

The patent reference 1 listed above discloses the immersion of a substrate for which exposure treatment has been completed in a supercritical fluid, thereby achieving a developing effect, a resist removal effect, and a foreign matter cleaning effect.

The patent reference 2 listed above discloses a method in which the developing solution left following developing treatment, or the rinse solution left following developing and rinse treatments, is substituted with a fluorine-based inert liquid, and the surface of the substrate is then dried using a nitrogen blower.

The background art relating to the present invention is described below.

Lithography techniques are widely used in the production of microstructures within devices such as semiconductor devices, but as device structures have been increasingly miniaturized, demand has also grown for the production of finer resist patterns within the lithography process.

Currently, lithography methods can be used in the formation of fine patterns with line widths of no more than 0.20 μm, but recently, demand has also grown for fine patterns with a large film thickness and a narrow line width, that is, an extremely high so-called aspect ratio (resist height/resist pattern width).

However, these types of fine resist patterns and resist patterns with extremely high aspect ratios tend to be prone to collapse in the steps following developing treatment.

As a countermeasure to this problem of pattern collapse, a patent reference 3 listed below discloses a method that employs a critical drying method, based on the finding that in the drying step following rinsing, when the liquid surface of the rinse solution trapped within the resist pattern falls below the surface of the resist pattern, the surface tension of the rinse solution applies an attractive force to the resist pattern, thus causing pattern collapse.

In other words, a method is disclosed wherein following formation of a resist film comprising polymethylmethacrylate (PMMA) on a substrate, the resist is exposed with a desired pattern using X-rays, and is subsequently developed in an organic solvent-based developing solution comprising a mixture of methyl isobutyl ketone (MIBK) and isopropyl alcohol (IPA). The entire substrate is then rinsed with IPA, the residual IPA left on the substrate is substituted with liquid CO₂, and this liquid CO₂ then passes through a critical state and converts to a gaseous state, meaning no surface tension acts on the resist pattern during the drying process following developing.

(Patent Reference 3)

Japanese Unexamined Patent Application, First Publication No. Hei 5-315241, paragraphs [0022] to [0031].

In recent years the development of novel resist materials has progressed significantly, and in many cases, an aqueous alkali solution is used as the developing solution, while pure water is used for the rinse solution.

However, even if the method disclosed in the above patent reference 3 is applied to a drying process following developing using an aqueous alkali solution, all of the moisture trapped within the resist pattern on the substrate cannot be removed, and the residual moisture causes surface tension to act on the resist pattern during the drying step, causing pattern collapse.

Furthermore, even in those cases where the alkali developing solution is rinsed with pure water, moisture form the rinse water causes the same problems.

### DISCLOSURE OF INVENTION

Accordingly, an object of the present invention is to provide a positive resist composition, which is used in a resist pattern formation method that comprises a critical drying step, and enables the prevention of resist pattern collapse during a drying step following alkali developing.

In order to achieve the above object, a positive resist composition of the present invention is a positive resist composition that is used in a resist pattern formation method comprising a step, within the lithography process, for substituting the solution remaining on the substrate following alkali developing with a critical drying liquid, and then drying the critical drying liquid by causing passage through a critical state, wherein the positive resist composition comprises a resin component (A), which has an alkali-soluble unit content of less than 20 mol %, contains an acid dissociable, dissolution inhibiting group, and displays increased alkali solubility under the action of acid, an acid generator component (B) that generates acid on exposure, and an organic solvent (C) for dissolving the components (A) and (B), and the component (A) comprises a structural unit (a1) containing an acid dissociable, dissolution inhibiting group, a structural unit (a2) containing a lactone unit, and a structural unit (a3) containing a polycyclic group with an alcoholic hydroxyl group.

The lithography process typically comprises steps for sequentially conducting resist application, prebaking, selective exposure, post exposure baking, and alkali developing.

Furthermore, the term “exposure” also includes irradiation with an electron beam.

By using a positive resist composition of the present invention, the collapse of very fine resist patterns during the drying step following developing treatment can be prevented, enabling a resist pattern of favorable shape to be formed with excellent yield.

### BRIEF DESCRIPTION OF THE DRAWINGS

FIG. 1 is a diagram describing a drying step according to the present invention, in which a resist pattern is dried by causing a critical drying liquid to pass through a critical state.

### BEST MODE FOR CARRYING OUT THE INVENTION

As follows is a detailed description of the present invention.

[Positive Resist Composition]

A positive resist composition according to the present invention comprises a resin component (A), which has an alkali-soluble unit content of less than 20 mol %, contains an acid dissociable, dissolution inhibiting group, and displays increased alkali solubility under the action of acid, an acid generator component (B) that generates acid on exposure, and an organic solvent (C) for dissolving the components (A) and (B), wherein the component (A) comprises a structural unit (a1) containing an acid dissociable, dissolution inhibiting group, a structural unit (a2) containing a lactone unit, and a structural unit (a3) containing a polycyclic group with an alcoholic hydroxyl group.

In this type of positive resist composition, when acid generated from the component (B) acts on the resin, the acid dissociable, dissolution inhibiting group contained within the component (A) dissociates, converting the entire component (A) from an alkali insoluble state to an alkali soluble state.

Accordingly, during resist pattern formation, by selectively irradiating a positive resist composition applied to a substrate, through a mask pattern, the alkali solubility of the exposed sections improves, enabling alkali developing to be conducted.

Examples of suitable positive resist compositions according to the present invention include ArF positive resist compositions that have been proposed as favorable materials for exposure methods using ArF excimer lasers, and KrF positive resist compositions that have been proposed as favorable materials for exposure methods using KrF excimer lasers, provided the aforementioned alkali-soluble unit content falls within the range described above.

The resin component (A) of a KrF positive resist composition typically comprises a structural unit derived from hydroxystyrene, and a structural unit derived from a hydroxystyrene in which the hydroxyl group has been substituted with an acid dissociable, dissolution inhibiting group, and/or a structural unit derived from a (meth)acrylate ester containing an acid dissociable, dissolution inhibiting group. Furthermore, the resin component (A) of a ArF positive resist composition typically comprises a resin containing a structural unit derived from a (meth)acrylate ester containing an acid dissociable, dissolution inhibiting group within the principal resin chain.

In the present invention, the term “(meth)acrylate” is a generic term meaning methacrylate and/or acrylate. A “structural unit” refers to a monomer unit used in producing a polymer.

In the present invention, an alkali-soluble unit refers specifically to a structural unit containing a phenolic hydroxyl group or a carboxyl group, and includes, for example, structural units derived from a hydroxystyrene shown below in [formula 1], structural units derived from an acrylic acid shown below in [formula 2], and structural units derived from a methacrylic acid shown below in [formula 3]. Alcoholic hydroxyl groups do not form an alkali-soluble unit as defined within the present invention. 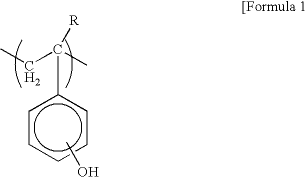
(wherein, R represents a hydrogen atom or a methyl group)

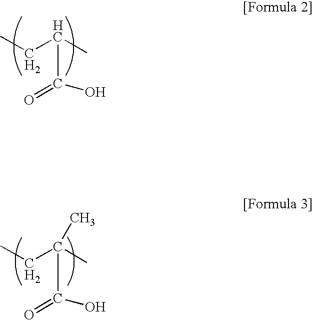

In the present invention, if the alkali-soluble unit content within the component (A) exceeds 20 mol %, then the resist pattern becomes prone to defects such as surface roughness, thickness loss, and separation from the substrate.

The alkali-soluble unit content within the component (A) is preferably no more than 10 mol %, and even more preferably 5 mol % or less, and most preferably zero.

[Resin Component (A)]

In a positive resist composition according to the present invention, the component (A) comprises a combination of monomer units with a plurality of different functions, such as the structural units described below.

A structural unit containing an acid dissociable, dissolution inhibiting group (hereafter also referred to as a first structural unit, or (a1)),

a structural unit containing a lactone unit (hereafter also referred to as a second structural unit, or (a2)),

a structural unit containing a polycyclic group with an alcoholic hydroxyl group (hereafter also referred to as a third structural unit, or (a3)), and

a structural unit containing a polycyclic group which differs from the acid dissociable, dissolution inhibiting group of the first structural unit, the lactone unit of the second structural unit, and the alcoholic hydroxyl group-containing polycyclic group of the third structural unit (hereafter also referred to as a fourth structural unit, or (a4)).

In the present invention, the term “lactone unit” is a group in which one hydrogen atom has been removed from a monocyclic or polycyclic lactone.

The units (a1) to (a3) are essential, whereas (a4) can be added as desired, in accordance with the resin characteristics required.

By combining (a1), (a2) and (a3), the solubility resistance relative to the substitution liquid can be increased, and the etching resistance, resolution, and adhesion between the resist film and the substrate also improve. These three structural units preferably account for at least 80 mol %, and even more preferably 90 mol % or greater, of the component (A).

In addition, including the unit (a4) within the component (A) provides a resin with excellent resolution, particularly for isolated patterns through to semi dense patterns (line and space patterns in which for a line width of 1, the space width is within a range from 1.2 to 2), and is consequently preferred.

For each of the units (a1) to (a4), a combination of a plurality of units may also be used.

[First Structural Unit (a1)]

A first structural unit (a1) of the component (A) may be either a structural unit derived from a (meth)acrylate ester containing an acid dissociable, dissolution inhibiting group, or a structural unit derived from a hydroxystyrene in which the hydroxyl group has been substituted with an acid dissociable, dissolution inhibiting group.

There are no particular restrictions on the acid dissociable, dissolution inhibiting group of the unit (a1), provided it displays an alkali dissolution inhibiting effect that causes the entire component (A) to be alkali insoluble prior to exposure, but dissociates under the action of acid generated from the aforementioned component (B) following exposure, causing the entire component (A) to become alkali soluble. Generally, groups which form a cyclic or chain-like tertiary alkyl ester with the carboxyl group of (meth)acrylic acid or the hydroxyl group of hydroxystyrene, tertiary alkoxycarbonyl groups, or chain-like alkoxyalkyl groups are the most widely used.

As the unit (a1), a structural unit derived from a (meth)acrylate ester, and comprising an acid dissociable, dissolution inhibiting group containing a polycyclic group, can be favorably used.

Examples of this polycyclic group include groups in which one hydrogen atom has been removed from a bicycloalkane, a tricycloalkane or a tetracycloalkane or the like. Specific examples include groups in which one hydrogen atom has been removed from a polycycloalkane such as adamantane, norbornane, isobornane, tricyclodecane or tetracyclododecane. These types of polycyclic groups can be appropriately selected from the multitude of groups proposed for use with ArF resists. Of these groups, adamantyl groups, norbornyl groups and tetracyclododecanyl groups are preferred in terms of industrial availability.

Furthermore, as the unit (a1), a structural unit derived from hydroxystyrene, in which the hydroxyl group has been substituted with an acid dissociable, dissolution inhibiting group, can also be favorably used.

Ideal monomer units for the first structural unit (a1) are shown below in [formula 4] through [formula 17]. 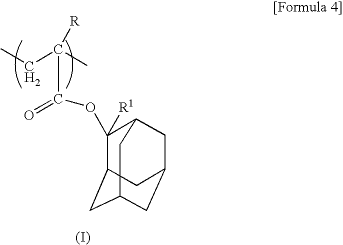
(wherein, R represents a hydrogen atom or a methyl group, and R¹ represents a lower alkyl group) 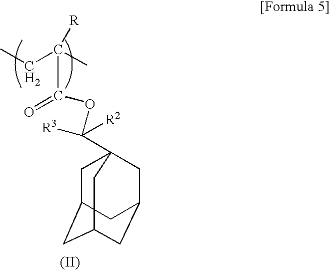
(wherein, R represents a hydrogen atom or a methyl group, and R² and R³ each represent, independently, a lower alkyl group) 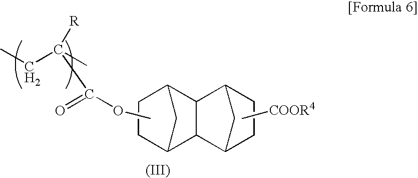
(wherein, R represents a hydrogen atom or a methyl group, and R⁴ represents a tertiary alkyl group) 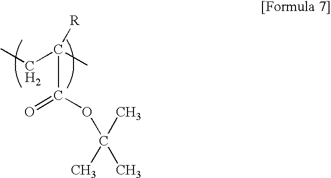
(wherein, R represents a hydrogen atom or a methyl group) 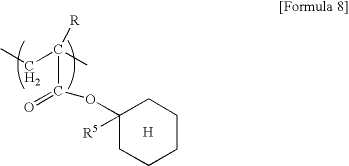
(wherein, R represents a hydrogen atom or a methyl group, and R⁵ represents a methyl group) 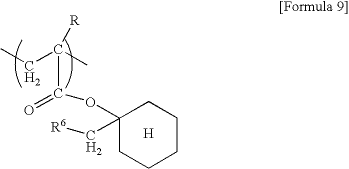
(wherein, R represents a hydrogen atom or a methyl group, and R⁶ represents a lower alkyl group) 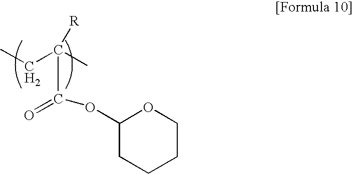
(wherein, R represents a hydrogen atom or a methyl group) 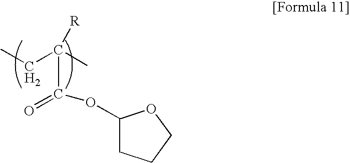
(wherein, R represents a hydrogen atom or a methyl group) 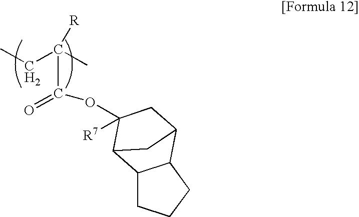
(wherein, R represents a hydrogen atom or a methyl group, and R⁷ represents a lower alkyl group) 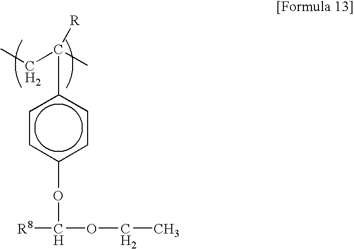
(wherein, R represents a hydrogen atom or a methyl group, and R⁸ represents a lower alkyl group) 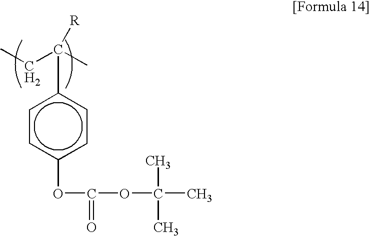
(wherein, R represents a hydrogen atom or a methyl group) 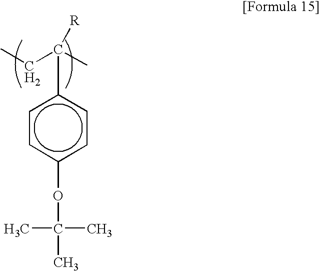
(wherein, R represents a hydrogen atom or a methyl group) 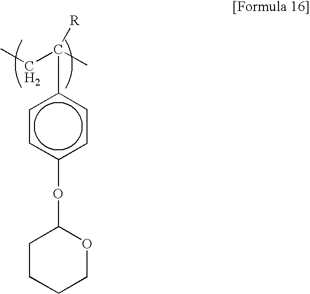
(wherein, R represents a hydrogen atom or a methyl group) 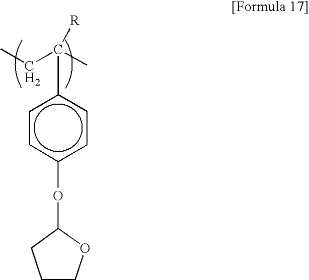
(wherein, R represents a hydrogen atom or a methyl group)

Within the above formulas, the groups R¹ to R³ and R⁶ to R⁸ each preferably represent a straight chain or branched lower alkyl group of 1 to 5 carbon atoms, and specific examples include a methyl group, ethyl group, propyl group, isopropyl group, n-butyl group, isobutyl group, tert-butyl group, pentyl group, isopentyl group and neopentyl group. From the viewpoint of industrial availability, a methyl group or an ethyl group is preferred.

Furthermore, R⁴ represents a tertiary alkyl group such as a tert-butyl group or a tert-amyl group, although a tert-butyl group is preferred industrially.

As the first structural unit (a1), of all the units described above, structural units represented by the general formulas (I), (II) and (III) generate resist patterns following developing treatment that are particularly resistant to erosion by the substitution liquid used in post-treatment, and are consequently the most preferred.

[Second Structural Unit (a2)]

A second structural unit (a2) of the component (A) contains a lactone unit, and is consequently effective in increasing the adhesion between the resist film and the substrate, and improving the affinity with the developing solution.

A unit (a2) of the present invention may be any unit which contains a lactone unit and is copolymerizable with the other structural units of the component (A).

Examples of suitable monocyclic lactone units include groups in which one hydrogen atom has been removed from γ-butyrolactone. Furthermore, examples of suitable polycyclic lactones include groups in which one hydrogen atom has been removed from a lactone-containing bicycloalkane.

As the unit (a2), structural units containing a lactone unit, and derived from a (meth)acrylate ester are preferred.

Ideal monomer units for the second structural unit (a2) are shown below in [formula 18] through [formula 20]. 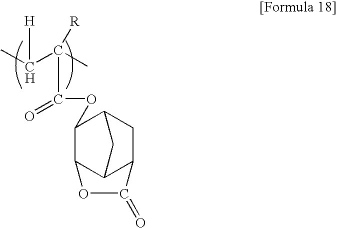
(wherein, R represents a hydrogen atom or a methyl group) 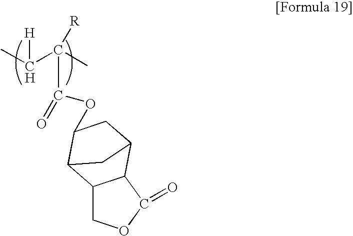
(wherein, R represents a hydrogen atom or a methyl group) 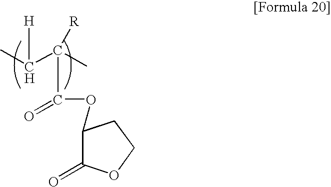
(wherein, R represents a hydrogen atom or a methyl group)

Of the above structural units, γ-butyrolactone esters of (meth)acrylic acid with an ester linkage at the α carbon atom, or norbornane lactone esters such as those shown in [formula 18] and [formula 19] are particularly preferred in terms of industrial availability.

[Third Structural Unit (a3)]

Because the hydroxyl group of the alcoholic hydroxyl group-containing polycyclic group of the third structural unit (a3) of the component (A) is a polar group, use of this unit results in an increased affinity for the entire component (A) relative to the developing solution, and an improvement in the alkali solubility of the exposed portions. Accordingly, (a3) contributes to an improvement in the resolution.

As the polycyclic group in the unit (a3), any polycyclic group can be appropriately selected from the various polycyclic groups listed in the above description for the first structural unit (a1).

There are no particular restrictions on the alcoholic hydroxyl group-containing polycyclic group in the unit (a3), and for example, a hydroxyl group-containing adamantyl group can be favorably used.

In addition, if this hydroxyl group-containing adamantyl group is a group represented by a general formula (IV) shown below, then it improve the resist composition in the dry etching resistance improves, and in the verticalness of the cross-sectional shape of the pattern, both of which are desirable. 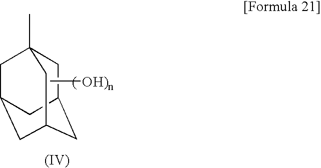
(wherein, n represents an integer from 1 to 3)

The third structural unit (a3) may be any unit which contains an aforementioned alcoholic hydroxyl group-containing polycyclic group, and is copolymerizable with the other structural units of the component (A).

Structural units derived from (meth)acrylate esters are particularly preferred.

Specifically, structural units represented by a general formula (IVa) shown below are preferred. 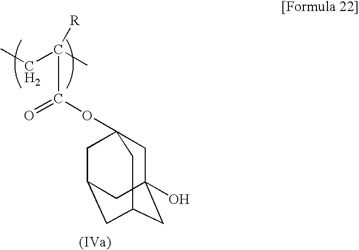
(wherein, R represents a hydrogen atom or a methyl group)
[Fourth Structural Unit (a4)]

In a unit (a4), a polycyclic group which “differs from the acid dissociable, dissolution inhibiting group, the lactone unit, and the alcoholic hydroxyl group-containing polycyclic group” means that in the component (A), the polycyclic group of the structural unit (a4) is a polycyclic group which does not duplicate the acid dissociable, dissolution inhibiting group of the first structural unit (a1), the lactone unit of the second structural unit (a2), or the alcoholic hydroxyl group-containing polycyclic group of the third structural unit (a3), and also means that the unit (a4) does not have the acid dissociable, dissolution inhibiting group of the first structural unit, the lactone unit of the second structural unit, or the alcoholic hydroxyl group containing polycyclic group of the third structural unit, which constitute the component (A).

There are no particular restrictions on the polycyclic group of the unit (a4), provided it is selected so as not to duplicate any of the structural units used in the units (a1) to (a3) of a single component (A). For example, as the polycyclic group in the unit (a4), aliphatic polycyclic groups like those listed in the above description for the structural unit (a1) can be used, and any of the multitude of materials conventionally used for ArF positive resist materials can be used.

From the viewpoint of industrial availability, one or more groups selected from amongst tricyclodecanyl groups, adamantyl groups or tetracyclododecanyl groups is preferred.

The unit (a4) may be any unit which contains an aforementioned polycyclic group, and is copolymerizable with the other structural units of the component (A).

Preferred examples of (a4) are shown below in [formula 23] through [formula 25]. 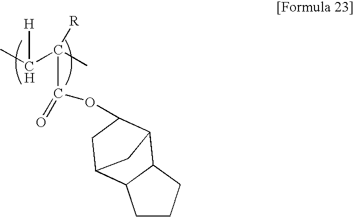
(wherein, R represents a hydrogen atom or a methyl group) 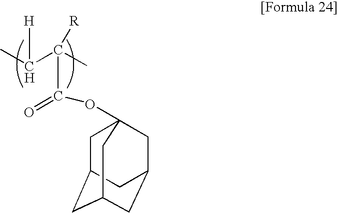
(wherein, R represents a hydrogen atom or a methyl group) 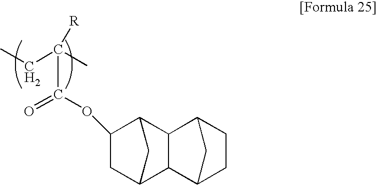
(wherein, R represents a hydrogen atom or a methyl group)

In the present invention, component (A) compositions in which the first structural unit (a1) accounts for 20 to 60 mol %, and preferably from 30 to 50 mol %, of the combined total of all the structural units of the component (A) display excellent resolution, and are consequently preferred.

Furthermore, compositions in which the second structural unit (a2) accounts for 20 to 60 mol %, and preferably from 30 to 50 mol %, of the combined total of all the structural units of the component (A) display excellent resolution, and are consequently preferred.

Furthermore, compositions in which the third structural unit (a3) accounts for 5 to 50 mol %, and preferably from 10 to 40 mol %, of the combined total of all the structural units of the component (A) display excellent resist pattern shape, and are consequently preferred.

In those cases where the fourth structural unit (a4) is used, compositions in which the unit (a4) accounts for 1 to 30 mol %, and preferably from 5 to 20 mol %, of the combined total of all the structural units of the component (A) offer superior resolution for isolated patterns through to semi-dense patterns, and are consequently preferred.

Furthermore, there are no particular restrictions on the weight average molecular weight (the polystyrene equivalent value, this also applies to subsequent molecular weight values) of the component (A), although values are typically within a range from 5,000 to 30,000, and preferably from 8,000 to 20,000. If the molecular weight is greater than this range, then the solubility of the component in the resist solvent deteriorates, whereas if the molecular weight is too small, there is a danger of a deterioration in the cross sectional shape of the resist pattern.

The resin component (A) in the present invention can be produced easily by a conventional radical polymerization of monomers corresponding with the structural units (a1), (a2), (a3), and where required (a4), using a radical polymerization initiator such as azobisisobutyronitrile (AIBN). The resin component (A) preferably comprises at least one unit selected from the above general formulas (I) through (III) as the structural unit (a1).

Furthermore, in order to ensure that the alkali-soluble unit content within the component (A) is less than 20 mol %, the proportion of monomers containing alkali-soluble units within the combination of all the monomers subjected to copolymerization should be restricted to less than 20 mol %.

[Acid Generator Component (B)]

In the present invention, as the acid generator component (B), a compound appropriately selected from known materials used as acid generators in conventional chemically amplified resists can be used.

Examples of suitable acid generators include onium salts such as diphenyliodonium trifluoromethanesulfonate, (4-methoxyphenyl)phenyliodonium trifluoromethanesulfonate, bis(p-tert-butylphenyl)iodonium trifluoromethanesulfonate, triphenylsulfonium trifluoromethanesulfonate, (4-methoxyphenyl)diphenylsulfonium trifluoromethanesulfonate, (4-methylphenyl)diphenylsulfonium nonafluorobutanesulfonate, (p-tert-butylphenyl)diphenylsulfonium trifluoromethanesulfonate, diphenyliodonium nonafluorobutanesulfonate, bis(p-tert-butylphenyl)iodonium nonafluorobutanesulfonate, and triphenylsulfonium nonafluorobutanesulfonate. Of these, onium salts with a fluorinated alkylsulfonate ion as the anion are particularly preferred.

As this component (B), either a single acid generator or a combination of two or more acid generators may be used.

The quantity used of the component (B) is typically within a range from 0.5 to 30 parts by weight, and preferably from 1 to 10 parts by weight, per 100 parts by weight of the component (A). At quantities less than 0.5 parts by weight, pattern formation does not proceed satisfactorily, whereas if the quantity exceeds 30 parts by weight, achieving a uniform solution becomes difficult, and there is a danger of a deterioration in the storage stability.

[Organic Solvent (C)]

A positive resist composition according to the present invention can be produced by dissolving the component (A) and the component (B), together with any optional components (D) described below, in an organic solvent (C).

The organic solvent (C) may be any solvent capable of dissolving the component (A) and the component (B) to generate a uniform solution, and one or more solvents selected from known materials used as the solvents for conventional chemically amplified resists can be used.

Specific examples of the solvent include ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate, methyl acetate, ethyl acetate, butyl acetate, methylpyruvate, ethyl pyruvate, methyl methoxypropionate, and ethyl ethoxypropionate. These organic solvents can be used alone, or as a mixed solvent of two or more different solvents.

In particular, mixed solvents of propylene glycol monomethyl ether acetate (PGMEA) and a polar solvent containing a hydroxyl group or a lactone such as propylene glycol monomethyl ether (PGME), ethyl lactate (EL) or γ-butyrolactone offer improved storage stability for positive resist compositions, and are consequently preferred. In cases in which EL is mixed with PGMEA, the weight ratio of PGMEA:EL is preferably within a range from 6:4 to 4:6.

In cases where PGME is mixed with PGMEA, the weight ratio of PGMEA:PGME is typically within a range from 8:2 to 2:8, and preferably from 8:2 to 5:5.

Mixed solvents of PGMEA and PGME improve the storage stability of positive resist compositions, particularly in those cases where a component (A) comprising all of the units (a1) through (a4) is used, and are consequently preferred.

In addition, mixed solvents containing at least one of PGMEA and ethyl lactate, together with γ-butyrolactone are also preferred as the organic solvent (C). In such cases, the weight ratio of the former and latter components in the mixed solvent is preferably within a range from 70:30 to 95:5.

In a positive resist composition according to the present invention, there are no particular restrictions on the quantity of the component (C), although typically, a sufficient quantity of the component (C) is added to produce a solid fraction concentration within the resist composition of 3 to 30% by weight, with the actual value set in accordance with the resist film thickness.

[Other Components]

Furthermore, in a positive resist composition of the present invention, in order to improve the resist pattern shape and the long term stability (the post exposure stability of the latent image formed by the pattern-wise exposure of the resist layer), a secondary lower aliphatic amine or a tertiary lower aliphatic amine can also be added as an optional component (D).

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine and triethanolamine, and of these, alkanolamines such as triethanolamine are preferred.

These may be used alone, or in combinations of two or more different compounds.

These types of amines are typically added in quantities within a range from 0.01 to 2.0% by weight relative to the quantity of the component (A).

Other miscible additives can also be added to a positive type resist composition of the present invention according to need, including additive resins for improving the properties of the resist film, surfactants for improving the ease of application, dissolution inhibitors, plasticizers, stabilizers, colorants and halation prevention agents.

[Pattern Formation Method]

Next is a description of a pattern formation method according to the present invention.

First, a positive resist composition according to the present invention is applied to the top of a substrate such as a silicon wafer using a spinner or the like, and a prebake is then performed. The coating of the positive resist composition is then selectively exposed using an exposure apparatus, and is then subjected to PEB (post exposure baking). The term “selective exposure” includes both exposure through a mask pattern with an exposure light source, as described below, as well as irradiation through a mask pattern with an electron beam, and electron beam lithography without using a mask pattern. Subsequently, developing is conducted using an alkali developing liquid comprising an aqueous alkali solution, and the resist is then rinsed with pure water. This water rinsing step involves dripping or spraying water onto the substrate surface while rotating the substrate, thereby washing the developing solution, and the resist composition dissolved within the developing solution, off the substrate. In this manner, the coating of the positive resist composition is patterned into a shape that matches the mask pattern, yielding a wet resist pattern.

The steps up until this point can be conducted using conventional techniques. The operating conditions are preferably set in accordance with the makeup and the characteristics of the positive resist composition being used.

There are no particular restrictions on the wavelength used for the exposure, and a radiation such as an ArF excimer laser, a KrF excimer laser, a F₂ laser, EUV (extreme ultraviolet), VUV (vacuum ultraviolet), electron beam, X-ray or soft X-ray radiation can be used. The positive resist composition according to the present invention is particularly useful for KrF excimer lasers, ArF excimer lasers, and electron beams.

An organic or inorganic anti-reflective film may also be provided between the substrate and the applied coating of the resist composition.

The water rinsing step following the developing treatment can be omitted, but incorporating the water rinsing step to wash the alkali components of the alkali developing solution off the substrate is preferred. The description below focuses on an embodiment in which the water rinsing step is included.

Following water rinsing, the substrate is supplied to the subsequent substitution step with the undried resist pattern still immersed in pure water.

In the substitution step, an operation for substituting the liquid on the substrate, which is water in the case of this embodiment, is conducted either once or a plurality of times, so that the undried resist pattern is converted to a state of immersion within the substitution liquid. There are no particular restrictions on the operation used for substituting the liquid on the substrate with the substitution liquid, and suitable methods include immersing the substrate within the substitution liquid, and spraying the substrate with the substitution liquid.

Furthermore, in this substitution step, the liquid on the substrate may first be substituted with a first substitution liquid, and this first substitution liquid then substituted with a second substitution liquid, so that the undried resist pattern on the substrate is completely immersed within the second substitution liquid.

In this substitution step following water rinsing, the operation for substituting the liquid on the substrate with the substitution liquid is preferably conducted at least 2 times, thereby enabling a highly effective removal of the original liquid from the substrate.

As the substitution liquid of the present invention, any material can be used provided it is an inert liquid that does not react with the undried resist pattern, is capable of substituting the liquid present on the substrate, and is able to be substituted by a critical drying liquid of the present invention. Substitution liquids containing a surfactant are able to more efficiently replace the liquid on the substrate, and are consequently preferred.

Fluorine-based inert liquids can be favorably employed as the substitution liquid. Specific examples of such fluorine-based inert liquids include liquids comprising, as a principal component, a fluorine-based compound such as C₃HCl₂F₅, C₄F₉OCH₃, C₄F₉OC₂H₅, C₅H₃F₇, C₅H₂F₁₀, and C₂H₃Cl₂F. Fluorine-based inert liquids comprising one or more of these fluorine-based compounds mixed with an alcohol such as isopropyl alcohol, methanol, or ethanol are also preferred.

Furthermore, in those cases where, as described above, substitution is conducted in two stages using a first substitution liquid and a second substitution liquid, by using a liquid containing an added surfactant as the first substitution liquid, and a liquid containing no surfactant as the second substitution liquid, all traces of residual surfactant can be removed from the substrate surface by completion of the substitution step, which is desirable.

Using a liquid containing an added surfactant as the first substitution liquid is effective in those cases where a very fine pattern is formed, and particularly when a very fine pattern is formed using electron beam exposure.

Following the substitution step, the undried resist pattern is completely immersed within the substitution liquid, and the substrate is supplied to the subsequent drying step in this state.

In the drying step, first, the substitution liquid on the substrate is substituted with a critical drying liquid. The critical drying liquid can use a fluid that is capable of adopting a liquid phase during substitution of the substitution liquid, such as carbon dioxide, which is a gaseous fluid under normal temperature and pressure conditions, but can be liquefied by suitably adjusting the temperature and pressure of the substitution atmosphere.

As the critical drying liquid, fluids for which the critical temperature is at least 0° C. and the critical pressure is no more than 30 MPa can be favorably used. Specific examples include CO₂, H₂O, C₃H₆, N₂O, and CHF₃. The critical temperature (hereafter also referred to as Tc) and critical pressure (hereafter also referred to as Pc) for each of these fluids are shown below.

CO₂: Tc=31.1° C., Pc=approximately 7.38 MPa (72.8 atm.)

H₂O: Tc=374° C., Pc=approximately 22.0 MPa (217.6 atm.)

C₃H₆: Tc=92.3° C., Pc=approximately 4.6 MPa (45.6 atm.)

N₂O: Tc=36.5° C., Pc=approximately 7.27 MPa (71.7 atm.)

CHF₃: Tc=25.9° C., Pc=approximately 48.4 MPa (47.8 atm.)

Of these, carbon dioxide is preferred in terms of the conditions required for industrial application.

The description below focuses on an example in which liquid CO₂ is used as the critical drying liquid.

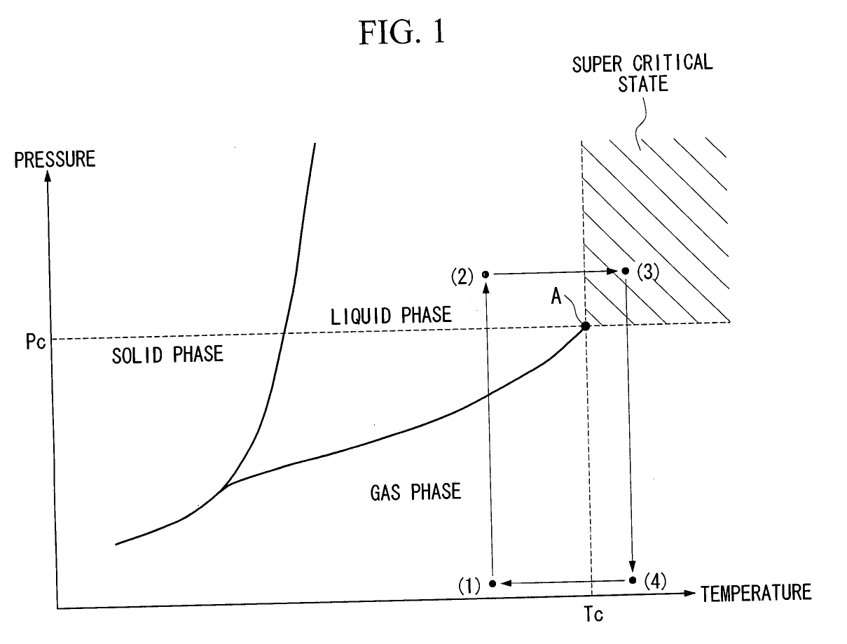

FIG. 1 is a diagram showing a schematic illustration of the gas-liquid equilibrium curve for a fluid. In the FIGURE, the point A marks the critical point, and in the case of carbon dioxide, this point occurs at Tc=31.1° C., and Pc=7.38 MPa.

There are no particular restrictions on the method used for substituting the substitution liquid on the substrate with the critical drying liquid, although in those cases where liquid CO₂ is used, following completion of the substitution step, the substrate, which comprises a resist pattern immersed within the substitution liquid, is placed inside a pressure vessel, the interior of which is capable of being pressurized. At this point, the temperature and pressure inside the pressure vessel are set to normal levels, namely, room temperature and atmospheric pressure (point (1) in FIG. 1). Subsequently, liquid CO₂ is fed into the vessel, while the temperature and pressure inside the vessel are adjusted to conditions under which CO₂ remains in the liquid phase (for example, point (2) in FIG. 1), and the inside of the pressure vessel is filled with liquid CO₂. With the temperature and pressure inside the pressure vessel maintained, the supply of liquid CO₂ is continued, so that the liquid CO₂ that has mixed with the substitution liquid flows out of the pressure vessel, thereby substituting the substitution liquid on the surface of the substrate with a critical drying liquid (liquid CO₂).

The critical drying liquid is then dried by passage through the critical state. Specifically, the inside of the pressure vessel is adjusted to a temperature and pressure that causes the critical drying liquid to reach a supercritical state (for example, point (3) in FIG. 1), and with that temperature maintained, the supercritical state critical drying liquid is then expelled from the pressure vessel. This causes the pressure of the critical drying liquid to fall, reaching a temperature and pressure shown by a point (4) for example, and the liquid on the substrate is then removed in a gaseous state, leaving the substrate dry. If required, the inside of the pressure vessel can then be cooled to room temperature.

In those cases where liquid CO₂ is used as the critical drying liquid, the substitution liquid on the substrate is replaced with liquid CO₂, and the inside of the pressure vessel is then adjusted to a temperature of at least 31.1° C., and a pressure of at least 7.38 MPa, thereby placing the CO₂ in a supercritical state. Subsequently, with the temperature maintained at 31.1° C. or higher, the CO₂ is allowed to gradually leak from the vessel, and once the pressure inside the pressure vessel falls below 7.38 MPa, and finally reaches atmospheric pressure. This causes the supercritical state CO₂ to convert to the gas phase, leaving the substrate in a dry state. Completing the drying step by cooling the temperature inside the pressure vessel to room temperature enables a dried resist pattern to be obtained.

When converting the critical drying liquid to a critical state, achieving a supercritical state by raising the temperature above the critical temperature and raising the pressure above the critical pressure is preferred, although even in a subcritical state, where the liquid is close to a supercritical state, but the temperature is less than the critical temperature and/or the pressure is less than the critical pressure, the liquid can still be effectively removed from the substrate.

By forming a resist pattern in this manner, collapse of the resist pattern during the drying step can be prevented, even for resist patterns with very small line widths, resist patterns with shapes that are prone to collapse, such as resist patterns with high aspect ratios, and line and space patterns with a small pitch, which have been particularly prone to pattern collapse.

In this description, the pitch of a line and space pattern is the combined distance of a resist pattern width and a space width in a direction across the width of the pattern lines.

Furthermore, even in cases where the water rinsing step is omitted, the same substitution and drying steps can be applied to the drying of the developing solution (aqueous alkali solution) from the surface of the developed substrate, and this enables prevention of the collapse of the resist pattern.

In addition, because the resist pattern is formed from a resist composition comprising a resin component (A) containing the above structural units (a1), (a2), and (a3), with an alkali-soluble unit content of less than 20 mol %, even when the undried resist pattern is brought into contact with a substitution liquid, defects such as surface roughening, thickness loss, and separation from the substrate do not occur, meaning a resist pattern with good shape precision can be obtained in high yield.

A resist pattern formed using a method according to the present invention is preferably a high density line and space pattern with a line width within a range from 20 to 130 nm, and preferably from 30 to 100 nm, an aspect ratio within a range from 2.0 to 10.0, and preferably from 2.5 to 8.0, and a pitch within a range from 40 to 300 nm, and preferably from 50 to 260 nm.

If the line width exceeds the above range, then formation of the resist pattern can be conducted using a conventional method, without relying on the method according to the present invention, whereas if the line width is smaller than the above range, then pattern formation becomes difficult.

If the aspect ratio is smaller than the above range, then formation of the resist pattern can be conducted using a conventional method, without relying on the method according to the present invention, whereas if the aspect ratio exceeds the above range, then pattern formation becomes difficult.

If the pitch exceeds the above range, then formation of the resist pattern can be conducted using a conventional method, without relying on the method according to the present invention, whereas if the pitch is smaller than the above range, then pattern formation becomes difficult.

Furthermore, by employing a critical drying step, and also using electron beam exposure, particularly fine resist patterns, and resist patterns with very high aspect ratios can be achieved. For example, even a very fine line and space pattern with a line width within a range from 20 to 100 nm, and preferably from 20 to 80 nm, and an aspect ratio within a range from 2.0 to 10.0 can be formed without pattern collapse.

### EXAMPLES

As follows is a more detailed description of the present invention, based on a series of examples.

### Example 1

A component (A), a component (B) and a component (D) described below were dissolved uniformly in a component (C), yielding a positive resist composition.

As the component (A), 100 parts by weight of an acrylate ester-based copolymer comprising the three structural units shown in [formula 26] was used. The proportions p, q and r of each of the structural units used in preparing the component (A) were p=40 mol %, q=40 mol % and r=20 mol % respectively.

The alkali-soluble unit content within the thus prepared component (A) was 0 mol %, and the weight average molecular weight of the component (A) was 10,000.

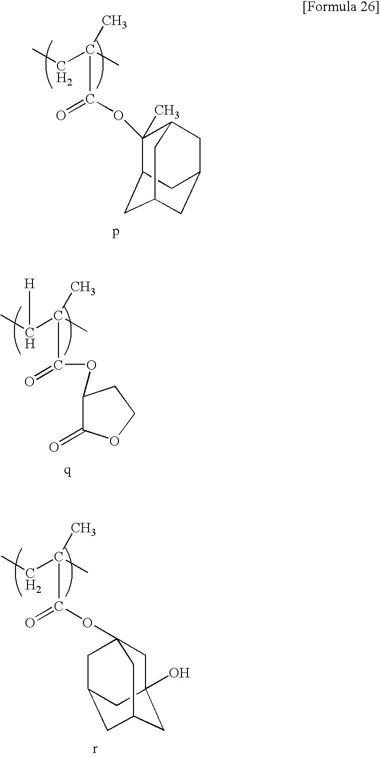

As the component (B), 2.0 parts by weight of triphenylsulfonium nonafluorobutanesulfonate and 0.6 parts by weight of triphenylsulfonium trifluoromethanesulfonate were used.

As the component (C), a mixed solvent of 450 parts by weight of propylene glycol monomethyl ether acetate and 300 parts by weight of ethyl lactate was used.

As the component (D), 0.3 parts by weight of triethanolamine was used.

Subsequently, the prepared positive resist composition was applied to the surface of a silicon wafer using a spinner, and was then prebaked and dried on a hot plate at 130° C. for 90 seconds, thus forming a resist layer with a film thickness of 340 nm.

Next, this layer was selectively irradiated with an ArF excimer laser (193 nm) through a phase shift mask, using an ArF exposure apparatus S-302 (manufactured by Nikon Corporation, (NA (numerical aperture)=0.60, σ=0.40).

A PEB treatment was then performed at 130° C. for 90 seconds, and the resist layer was then subjected to puddle development in an alkali developing solution, for 60 seconds at 23° C. The substrate was then rinsed with pure water for 180 seconds. As the alkali developing solution, a 2.38% by weight aqueous solution of tetramethylammonium hydroxide was used.

The rinsed substrate was immersed in a first substitution liquid, and following replacement of the liquid on the substrate with this first substitution liquid, the substrate was immersed in a second substitution liquid, thereby replacing the liquid on the substrate with this second substitution liquid. As the first substitution liquid, a fluorine-based inert liquid comprising CF₃CF₂CHCl₂ and CClF₂CF₂CHClF as primary components, and also containing a surfactant (brand name: AK225DW, manufactured by Asahi Glass Co., Ltd.) was used, and as the second substitution liquid, a product AK225 manufactured by Asahi Glass Co., Ltd, containing only the above fluorine-based inert compounds as primary components, was used. These liquids are marketed as cleaning agents for use on members formed from metal, plastics, or rubbers.

Subsequently, the substrate was subjected to critical drying using a microstructure drying device (SRD-2020, manufactured by Hitachi Science Systems, Ltd.).

In other words, the substrate was first placed inside a pressure vessel. At this point, the temperature inside the pressure vessel was room temperature (23° C.) and the pressure was atmospheric pressure (the point (1) in FIG. 1).

Subsequently, liquid CO₂ was fed into the vessel, while the pressure inside the vessel was raised to 7.5 MPa. The temperature was held at 23° C. (the point (2) in FIG. 1). With the temperature and pressure maintained inside the pressure vessel, liquid CO₂ was supplied continuously to the pressure vessel, so that the liquid CO₂ inside the pressure vessel was caused to flow out of the vessel, thereby substituting the substitution liquid on the surface of the substrate with a critical drying liquid.

Subsequently, with the pressure inside the pressure vessel maintained at 7.5 MPa, the temperature was raised to 35° C. at a rate of temperature increase of 2° C./minute, thereby placing the CO₂ inside the pressure vessel in a supercritical state (the point (3) in FIG. 1).

With the temperature maintained at 35° C. or higher, the CO₂ was allowed to gradually leak from the vessel. This caused the pressure inside the pressure vessel to gradually fall to atmospheric pressure, thereby converting the CO₂ to a gaseous state (the point (4) in FIG. 1).

The temperature inside the pressure vessel was then lowered to room temperature, completing the drying process.

The thus dried substrate comprised a line and space pattern with a line width of 90 nm, an aspect ratio of 3.8, and a pitch of 180 nm, which had been formed with a favorable shape, and with no pattern collapse.

### Comparative Example 1

The process of the example 1 was repeated up to and including the water rinsing step, and the substrate was then subjected to spin drying by rotating the substrate, and then heating on a hot plate at 100° C. to remove any residual pure water.

The thus dried substrate displayed a resist pattern of favorable shape, but adjacent patterns had leaned towards one another.

### Example 2

When the process of the example 1 was repeated, and the exposure dose was increased (overdose) to form an even finer resist pattern, a line and space pattern with a line width of 48 nm, an aspect ratio of 7.1, and a pitch of 180 nm was formed. The shape of the resist pattern was favorable, and no pattern collapse had occurred.

### Comparative Example 2

With the exception of altering the component (A) to 100 parts by weight of a resin in which the proportions of the three structural units shown in [formula 26] had been altered to p=30 mol %, q=30 mol % and r=10 mol % respectively, and an additional 30 mol % of a structural unit represented by the [formula 3] had been incorporated, a resist composition was prepared in the same manner as the example 1.

When the thus obtained resist composition was used to form a resist pattern in the same manner as the example 1, a line and space pattern with a line width of 90 nm and a pitch of 180 nm was obtained, but when this line and space pattern was immersed in the first substitution liquid, surface roughening, thickness loss, and separation form the substrate all occurred, leaving a very poor pattern shape.

### Example 3

As the component (A), the same copolymer as the example 1 was used.

As the component (B), 6.82 parts by weight of triphenylsulfonium nonafluorobutanesulfonate was used.

As the component (C), a mixed solvent of 450 parts by weight of propylene glycol monomethyl ether acetate and 300 parts by weight of propylene glycol monomethyl ether was used.

As the component (D), 0.3 parts by weight of triethanolamine was used.

The component (A), the component (B), the component (D), and 0.05 parts by weight of a non-ionic fluorine/silicone-based surfactant (brand name: Megafac R-08 (manufactured by Dainippon Ink and Chemicals, Incorporated)) were dissolved uniformly in the component (C), thus yielding a positive resist composition.

Subsequently, the thus obtained positive resist composition was applied to the surface of a hexamethyldisilazane-treated silicon wafer using a spinner, and was then prebaked and dried on a hot plate at 150° C. for 90 seconds, thus forming a resist layer with a film thickness of 340 nm.

Next, this layer was selectively exposed using an electron beam lithography apparatus (HL-800D, manufactured by Hitachi, Ltd., accelerating voltage 70 kV), using a method in which the pattern was formed by direct irradiation of the electron beam onto the photoresist layer.

A PEB treatment was then performed at 140° C. for 90 seconds, and the resist layer was then subjected to dipping development in an alkali developing solution, for 60 seconds at 23° C. The substrate was then rinsed with pure water for 60 seconds. As the alkali developing solution, a 2.38% by weight aqueous solution of tetramethylammonium hydroxide was used.

The rinsed substrate was immersed in a first substitution liquid for 60 seconds, and following replacement of the liquid on the substrate with this first substitution liquid, the substrate was immersed in a second substitution liquid for 60 seconds, thereby replacing the liquid on the substrate with this second substitution liquid. The first and second substitution liquids used the same products AK225DW and AK225 as those used in the example 1.

The substrate was then subjected to critical drying using a microstructure drying device in the same manner as the example 1.

The thus dried substrate comprised a line and space pattern with a line width of 70 nm, an aspect ratio of 4.86, and a pitch of 140 nm, which had been formed with a favorable shape, and with no pattern collapse.

### Example 4

With the exception of altering the first substitution liquid to a product AK225DH, manufactured by Asahi Glass Co., Ltd., comprising CF₃CF₂CHCl₂ and CClF₂CF₂CHClF as primary components, and also containing a surfactant, a resist pattern was formed in the same manner as the example 3. A line and space pattern with a line width of 70 nm, an aspect ratio of 4.86, and a pitch of 140 nm was formed on the substrate, with a favorable pattern shape and no pattern collapse.

### INDUSTRIAL APPLICABILITY

As described above, according to the present invention, the collapse of very fine resist patterns during the drying step following developing treatment can be prevented, and a resist pattern of favorable shape can be formed with excellent yield, which is industrially extremely useful.

1. A positive resist composition that is used in a resist pattern formation method comprising a step, within a lithography process, for substituting a liquid remaining on a substrate following alkali developing with a critical drying liquid, and then drying said critical drying liquid by causing passage through a critical state, wherein said positive resist composition comprises a resin component (A), which has an alkali-soluble unit content of less than 20 mol %, contains an acid dissociable, dissolution inhibiting group, and displays increased alkali solubility under action of acid, an acid generator component (B) that generates acid on exposure, and an organic solvent (C) for dissolving said components (A) and (B), and said component (A) comprises a structural unit (a1) containing an acid dissociable, dissolution inhibiting group, a structural unit (a2) containing a lactone unit, and a structural unit (a3) containing a polycyclic group with an alcoholic hydroxyl group.

2. A positive resist composition according to claim 1, wherein said alkali-soluble unit is at least one unit selected from a group consisting of structural units containing a phenolic hydroxyl group, and structural units containing a carboxyl group.

3. A positive resist composition according to claim 1, wherein quantities of said structural units (a1) to (a3) within said component (A) are from 20 to 60 mol % for said (a1), from 20 to 60 mol % for said (a2), and from 5 to 50 mol % for said (a3), and said alkali-soluble unit content is zero.

4. A positive resist composition according to claim 1, wherein said component (A) further comprises a structural unit (a4) containing a polycyclic group that differs from said acid dissociable, dissolution inhibiting group, said lactone unit, and said polycyclic group with an alcoholic hydroxyl group.

5. A positive resist composition according to claim 4, wherein quantities of said structural units (a1) to (a4) within said component (A) are from 20 to 60 mol % for said (a1), from 20 to 60 mol % for said (a2), from 5 to 50 mol % for said (a3), and from 1 to 30 mol % for said (a4), and said alkali-soluble unit content is zero.

6. A positive resist composition according to claim 1, wherein said component (B) is an onium salt with a fluorinated alkylsulfonate ion as an anion.

7. A positive resist composition according to claim 1, further comprising a secondary or tertiary lower aliphatic amine (D) in a quantity within a range from 0.01 to 2.0% by weight relative to said component (A).

8. A positive resist composition comprising:
a resin component (A) that displays increased alkali solubility under action of acid, comprising:
a structural unit (a1) containing an acid dissociable, dissolution inhibiting group,
a structural unit (a2) containing a lactone unit,
a structural unit (a3) containing a polycyclic group with an alcoholic hydroxyl group, and
an alkali-soluble unit of less than 20 mol %;
an acid generator component (B) that generates acid on exposure; and
an organic solvent (C) for dissolving said components (A) and (B).

9. The positive resist composition according to claim 8, wherein said alkali-soluble unit includes at least one unit selected from a group consisting of structural units containing a phenolic hydroxyl group, and structural units containing a carboxyl group, but does not include alcoholic hydroxyl groups.

10. The positive resist composition according to claim 8, wherein the structural units (a1), (a2), and (a3) are contained in the component (A) in an amount of from 20-60 mol %, from 20-60 mol %, and from 5-50 mol %, respectively, and no alkali-soluble unit is contained.

11. The positive resist composition according to claim 10, wherein the component (A) further comprises 1-30 mol % of a structural unit (a4) containing a polycyclic group that differs from the acid dissociable, dissolution inhibiting group, the lactone unit, and the polycyclic group with an alcoholic hydroxyl group.

12. The positive resist composition according to claim 8, wherein the acid dissociable, dissolution inhibiting group of the structural unit (a1) is a group which forms a cyclic or chain-like tertiary alkyl ester with the carboxyl group of (meth)acrylic acid or the hydroxyl group of hydroxystyrene; a tertiary alkoxycarbonyl group; or a chain-like alkoxyalkyl group.

13. The positive resist composition according to claim 8, wherein the component (B) is an onium salt with a fluorinated alkylsulfonate ion as an anion.

14. The positive resist composition according to claim 13, wherein the component (B) is contained in a range of from 0.5 to 30 parts by weight per 100 parts of the component (A).

15. A method of forming a resist pattern comprising a lithography process comprising:
forming and exposing a resist layer on a substrate using the resist pattern composition of claim 8;
conducting alkali developing of the exposed resist layer to form a resist pattern;
substituting a solution remaining on the substrate with a critical drying liquid; and
drying the critical drying liquid through its critical state.
